(19) United States
(12) Patent Application Publication
(10) Pub. No.: US 2023/0262698 A1
(43) Pub. Date: Aug. 17, 2023

(54) DEVICE AND METHOD FOR ALLOCATING RESOURCES IN WIRELESS COMMUNICATION SYSTEM

(71) Applicant: SAMSUNG ELECTRONICS CO., LTD., Suwon-si (KR)

(72) Inventors: Hyunil YOO, Suwon-si (KR); Yeohun YUN, Suwon-si (KR); Youngju HWANG, Suwon-si (KR); Seho MYUNG, Suwon-si (KR); Jeongho YEO, Suwon-si (KR); Chungryul CHANG, Suwon-si (KR); Kiseob HONG, Suwon-si (KR)

(73) Assignee: SAMSUNG ELECTRONICS CO., LTD., Suwon-si (KR)

(21) Appl. No.: 18/138,388

(22) Filed: Apr. 24, 2023

Related U.S. Application Data
(63) Continuation of application No. PCT/KR2021/014836, filed on Oct. 21, 2021.

(30) Foreign Application Priority Data
Oct. 23, 2020 (KR) 10-2020-0138623

(51) Int. Cl. H04W 72/1268; H04W 24/04

(52) U.S. Cl. CPC H04W 72/1268; H04W 24/04

(57) ABSTRACT

A method performed by a base station in a wireless communication system includes: identifying initial transmission scheduling intervals of terminals within a first cell; and determining whether to allocate resources to a first terminal in a second cell, based on the initial transmission scheduling intervals.

### CROSS-REFERENCE TO RELATED APPLICATIONS

This application is a by-pass continuation application of International Application No. PCT/KR2021/014836, filed on Oct. 21, 2021, which is based on and claims priority to Korean Patent Application No. 10-2020-0138623, filed on Oct. 23, 2020, in the Korean Intellectual Property Office, the disclosures of which are incorporated by reference herein in their entireties.

### TECHNICAL FIELD

The present disclosure relates generally to a wireless communication system, and more specifically, to a device and method for allocating resources in the wireless communication system.

### BACKGROUND

In the past, a voice call service in a mobile communication system was provided through a public switched telephone network (PSTN). However, due to the recent development of communication technology, a broadband mobile data communication service has become possible, and accordingly, a voice call service based on data communication, that is, a voice over internet protocol (VoIP) service is provided. Accordingly, a user can use a VoIP call through an access network that presents internet protocol (IP) connectivity.

A long term evolution (LTE) system, which is a 4th generation (4G) mobile communication system currently defined in 3rd generation partnership project (3GPP), also supports a VoIP service. The VoIP service provided through the LTE system is also referred to as voice over LTE (VoLTE). A VoLTE service is one of the technologies of LTE/LTE-A, which is a packet switched scheme, and is a technology that enables a voice call like the existing 3G wireless communication that uses a circuit switched scheme. Compared to the past 3rd generation (3G) voice calls, this VoLTE service has excellent call quality by using a wide bandwidth and high-quality voice codec. Also, it is possible to switch to a video call during a VoLTE voice call, and the VoLTE video call can provide a high definition (HD) service with a resolution eight times higher than that of a 3G video call. A 5th generation (5G) new radio (NR) (or new radio access technology (RAT)) mobile communication system corresponding to the release-15 or higher version of the 3GPP standard can also support a voice over NR (VoNR) service similar to VoLTE.

Unlike VoIP, which can be used in mobile messenger applications, in VoLTE, a service provider or network operator controls a transmission speed according to network conditions and manages so that calls do not drop. Accordingly, VoLTE has a faster connection speed and maintains a high call quality compared to circuit switching. In this way, in order to provide real-time services such as VoLTE or VoNR, based on data communication, it is necessary to appropriately control a data transmission rate, a transmission delay, and other network management operations.

### SUMMARY

Based on the above discussion, the disclosed embodiments present a device and method for allocating resources in a wireless communication system.

Additionally, the disclosed embodiments present a device and method for allocating uplink radio resources in a wireless communication system.

Additionally, the disclosed embodiments present a device and method for determining radio resource allocation without a resource allocation request for an uplink voice duration in a wireless communication system.

Additionally, the disclosed embodiments present a device and method for estimating a buffer status of a terminal in consideration of whether a terminal is in an uplink voice duration, and a buffer status update period, and allocating uplink radio resources to the terminal, based on a buffer status estimate value, in a wireless communication system.

A method performed by a base station of the disclosed embodiments may include steps of identifying initial transmission scheduling intervals corresponding to terminals within a first cell, and determining whether to allocate resources to a first terminal in a second cell, based on the initial transmission scheduling intervals.

Abase station of the disclosed embodiments may include at least one transceiver and at least one processor operatively coupled with the at least one transceiver. The at least one processor may be configured to identify initial transmission scheduling intervals corresponding to terminals within a first cell, and determine whether or not to allocate resources to a first terminal in a second cell, based on the initial transmission scheduling intervals.

A device and method of the various disclosed embodiments may prevent overall service quality degradation by efficiently allocating radio resources to a terminal, in a real-time service such as a voice over internet protocol (VoIP) (e.g., voice over long term evolution (VoLTE) or voice over new radio (VoNR)).

Effects obtainable are not limited to the effects mentioned above, and other effects not mentioned would be clearly understood by those skilled in the art from the description below.

### BRIEF DESCRIPTION OF DRAWINGS

FIG. 1 illustrates a wireless communication system according to various embodiments of the present disclosure.

FIG. 2 illustrates a flowchart in which a base station controls a quality of service, based on the number of voice over long term evolution (VoLTE) terminals, according to an embodiment of the present disclosure.

FIG. 3A illustrates a flowchart in which a base station control a quality of service, based on a quality of service class identifier-1 (QCI-1) initial transmission scheduling interval, according to an embodiment of the present disclosure.

FIG. 3B illustrates a flowchart in which a base station controls a quality of service, based on a QCI-1 initial transmission scheduling interval, according to an embodiment of the present disclosure.

FIG. 4 illustrates a flowchart in which a base station controls a quality of service, based on the number of VoLTE terminals and a QCI-1 initial transmission scheduling interval, according to an embodiment of the present disclosure.

FIG. 5 illustrates a flowchart in which a base station controls a quality of service, based on the number of VoLTE terminals and a QCI-1 initial transmission scheduling interval, according to an embodiment of the present disclosure.

FIG. 6 illustrates a flowchart in which a base station controls a quality of service, based on an average control channel element (CCE) size required for uplink and downlink, according to an embodiment of the present disclosure.

FIG. 7 illustrates a flowchart in which a base station controls a quality of service, based on an uplink CCE fail rate, according to an embodiment of the present disclosure.

FIG. 8 illustrates a flowchart in which a base station controls a quality of service, based on an average CCE required for uplink and downlink and an uplink CCE fail rate, according to an embodiment of the present disclosure.

FIG. 9 illustrates a flowchart in which a base station controls a quality of service, based on an average CCE required for uplink and downlink and an uplink CCE fail rate, according to an embodiment of the present disclosure.

FIG. 10 illustrates a flowchart in which a base station controls a quality of service, based on at least one of the number of VoLTE terminals, a QCI-1 initial transmission scheduling interval, an average CCE required for uplink and downlink, or an uplink CCE fail rate, according to an embodiment of the present disclosure.

FIG. 11 illustrates a construction of a terminal according to various embodiments of the present disclosure.

FIG. 12 illustrates a construction of a base station according to various embodiments of the present disclosure.

### DETAILED DESCRIPTION

Terms used in the present disclosure are only used to describe a specific embodiment, and may not be intended to limit the scope of other embodiments. Singular expressions may include plural expressions unless the context clearly dictates otherwise. Terms used herein, including technical or scientific terms, may have the same meaning as those commonly understood by a person having an ordinary skill in the art described in the present disclosure. Among the terms used in the present disclosure, terms defined in general dictionaries may be interpreted as having the same or similar meanings as those in the context of the related art, and unless explicitly defined in the present disclosure, are not be interpreted as ideal or excessively formal meanings. In some cases, even terms defined in the present disclosure may not be interpreted to exclude embodiments of the present disclosure.

In various embodiments described below, a hardware access method is described as an example. However, since various embodiments include a technology using both hardware and software, the various embodiments do not exclude a software-based access method. Also, terms referring to signals, terms referring to channels, terms referring to control information, terms referring to network entities, terms referring to components of a device, and the like are illustrated for convenience of description. Accordingly, the present disclosure is not limited to the terms described below, and other terms having equivalent technical meanings may be used.

In the present disclosure, an expression of more than or less than may be used to determine whether a specific condition is satisfied or fulfilled, but this is only a description for expressing an example, and does not to exclude a description of equal to or more than, or equal to or less than. A condition described as ‘equal to or more than’ may be replaced with ‘exceed’, and a condition described as ‘equal to or less than’ may be replaced with ‘less than’, and a condition described as ‘equal to or more than, and less than’ may be replaced with ‘exceed, and equal to or less than’. Also, in the present invention, an instruction or indicator may mean indicating or determining whether to execute a specific operation, but may also mean a parameter or message corresponding to the specific operation.

Hereinafter, the present disclosure relates to a method and device for supporting efficient and continuous improved voice over long term evolution (VoLTE) communication between a base station and a terminal in a wireless communication system. More specifically, the present disclosure relates to a scheduling method and device for dynamic spectrum sharing (DSS). DSS means a technology of enabling a communication operator to switch to an NR communication system while maintaining an existing LTE communication system, by allowing long term evolution (LTE) and 5G new radio (NR) cells to coexist on the same carrier.

Since the number of NR terminals in a network increases and affects the performance of existing LTE terminals in the DSS situation, a method in which a base station performs efficient resource distribution and scheduling so as to maintain a quality of data communication based real-time service such as VoLTE is described.

Terms referring to network entities used in the following description, terms referring to control information (e.g., uplink grant, etc.), terms referring to components of a device, terms referring to communication messages (e.g., scheduling request (SR), buffer status report (BSR), etc.), terms referring to communication technologies, and the like are illustrated for convenience of description. Accordingly, the present disclosure is not limited to the terms described below, and other terms having equivalent technical meanings may be used.

Also, the present disclosure describes various embodiments using an LTE system, an LTE-advanced (LTE-A) system, and a 5G NR system, but this is only an example for explanation. Various embodiments of the present disclosure may be easily modified and applied to other communication systems.

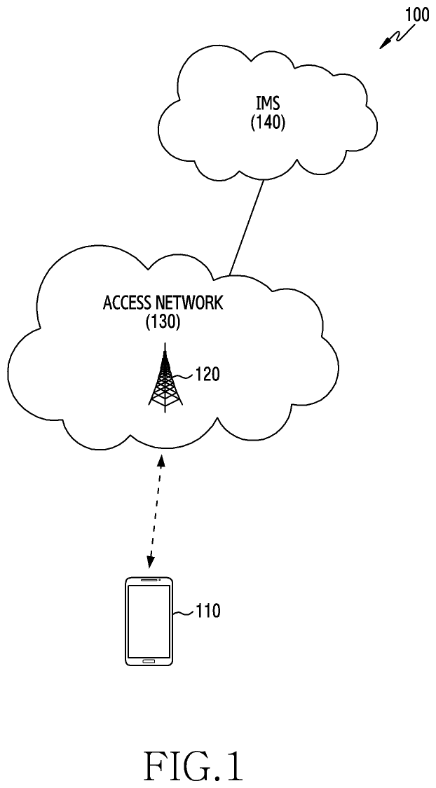

FIG. 1 illustrates a wireless communication system according to various embodiments of the present disclosure. FIG. 1 illustrates a terminal 110, an access network 130 including a base station 120, and an Internet protocol multimedia subsystem (IMS) 140, as some of nodes using a wireless channel in the wireless communication system 100.

The terminal 110 is a device used by a user and may perform communication through a wireless channel formed with the base station 120, that is, an access network. The terminal 110 may present a voice over internet protocol (VoIP) function, and execute an application for a VoIP service according to a user's command. Accordingly, the terminal 110 may transmit and receive voice packets for VoIP service with the base station 120. In various embodiments, the terminal 110 may be a portable electronic device, and may be one of a smart phone, a portable terminal, a mobile phone, a mobile pad, a media player, a tablet computer, a handheld computer or a personal digital assistant (PDA). In another embodiment, the terminal 110 may be a stationary device. Also, the terminal 110 may be a device combining two or more functions of the above-described devices. The terminal 110 may be referred to a ‘terminal’, ‘user equipment (UE)’, ‘mobile station (MS)’, ‘subscriber station’, ‘customer premises equipment (CPE)’, ‘remote terminal’, ‘wireless terminal’, ‘vehicle terminal’, ‘user device’ or other terms having equivalent technical meanings.

The base station 120 is a network infrastructure that presents radio access to the terminal 110. The base station 120 is one of entities constituting the access network 130, and has coverage defined as a certain geographical area, based on a distance over which signals may be transmitted. Hereinafter, the term ‘coverage’ used may refer to a service coverage area in the base station 120. The base station 120 may cover one cell or multiple cells. Here, the multiple cells may be distinguished by a supported frequency and a covered sector area. In addition to the base station, the base station 120 may be referred to as ‘access point (AP)’, ‘evolved node B (eNB)’, ‘5th generation (5G)node’, ‘5G-NR Node B (gNB)’, ‘wireless point’, ‘transmission/reception point (TRP)’, or other terms having equivalent technical meanings.

The access network 130 is a system for connecting the terminal 110 to an external network (e.g., an internet protocol (IP) network), and may further include not only the base station 120 but also other objects such as a serving gateway (S-GW), a packet data network gateway (P-GW), and a mobility management entity (MME).

The IMS 140 is a subsystem that manages sessions. The IMS 140 may be operated independently of the access network 130. The IMS 140 may present multimedia services such as voice, audio, video, and data, based on IP. When the terminal 110 makes a voice call with the other party through a VoIP service, voice packets are transmitted and received through the IMS 140. According to an embodiment, when the terminal 110 receives a VoLTE voice call through an LTE network, voice packets may be transmitted and received through the IMS 140. The IMS 140 may include at least one of a proxy-call session control function (P-CSCF), a serving-call session control function (S-CSCF), an interrogating-call session control function (I-CSCF), a PCRF, and a home subscriber server (HSS).

Although FIG. 1 describes the MME, the S-GW, the P-GW, etc., other wireless communication system environments other than the LTE environment may be considered. Embodiments may be applied in a wireless environment in which a new radio (NR) communication system is used. For example, an access and mobility management function (AMF) or a session management function (SMF) may be used instead of the MME, and a user plane function (UPF) may be used instead of the S-GW. Here, the AMF may be a network entity of a core network which manages the authentication and mobility of the terminal 110. The SMF may be a network entity of the core network which is in charge of a session management function. The UPF may be a network entity of the core network which is in charge of routing packets transmitted and received by the terminal 110.

A data voice service such as voice over long term evolution (VoLTE) between the terminal 110 and the base station 120 may be supported. However, owing to the coexistence of 5G new radio (NR) terminals and long term evolution (LTE) terminals located in a dynamic spectrum sharing (DSS) cell, the amount of resources that may be occupied by the LTE terminal is limited to the amount of resources occupied by the 5G NR terminal, so there is a possibility of deteriorating a quality of a VoLTE service of the LTE terminal. In a situation in which the quality of the VoLTE service is expected to be deteriorated due to the reduced resources as above, the quality may be maintained by handover of some terminals requiring the VoLTE service to other cells or other frequency bands. Here, the other frequency bands are possible to be used not only for DSS, but also may be used as an LTE-only cell or an NR-only cell.

The terminal 110 having data to be transmitted through uplink transmits a radio resource allocation request (a request for uplink grant) to the base station 120. According to an embodiment, according to the 3rd generation partnership project (3GPP) standard (Release 8 or higher), a means for requesting uplink radio resource allocation may include a method of transmitting a scheduling request (SR) or buffer status report (BSR) message. SR may be transmitted through a physical uplink control channel (PUCCH), and BSR may be transmitted through a medium access control (MAC) control element (CE) upon physical uplink shared channel transmission.

When the base station 120 receives a radio resource allocation request from the terminal 110, the base station 120 may perform resource allocation according to its own radio resource allocation policy. When the base station 120 succeeds in allocating resources to the terminal 110, the base station 120 transmits radio resource allocation information (uplink (UL) grant) to the terminal 110. In this case, the radio resource allocation information may be transmitted through a physical downlink control channel (PDCCH). Upon receiving the radio resource allocation information from the base station 120, the terminal 110 transmits uplink data to the base station 120 through a corresponding resource. Also, the terminal 110 may transmit a buffer status report (BSR) on the remaining data excepting the transmitted data, together. When the base station 120 receives the BSR, the base station 120 performs radio resource allocation again and repeats the above processes.

As described above, the conventional method in which the base station 120 receives a radio resource allocation request such as SR or BSR and allocates radio resources may cause an allocation delay in an environment in which a plurality of terminals compete for radio resource allocation under limited radio resources. In a voice service such as VoLTE of an embodiment, a quality of service may be deteriorated due to the radio resource allocation delay, which may become the cause of decreasing a voice user capacity.

However, the disclosed embodiments are not limited to such a VoIP service environment or an LTE environment. According to other embodiments, a method for radio resource allocation may be applied to all systems presenting a real-time service sensitive to a data transmission delay.

In a situation where a plurality of terminals compete for resource allocation, when resource allocation responsive to a request for radio resource allocation of an uplink voice duration of the terminal 110 is delayed or sufficient resource allocation is difficult, transmission of uplink voice data to be transmitted from the terminal 110 to the base station 120 may be delayed or an error may occur, and as a result, a voice service quality deterioration problem for the terminal 110 may occur. Therefore, the disclosed embodiments may predict a possibility of deterioration of the performance of VoLTE UEs in a DSS cell, and perform appropriate inter-frequency or inter-frequency-band or inter-cell handover or offloading, thereby maintaining a VoLTE quality of UEs. (In this disclosure, it may be referred to as DSS offloading in some cases.)

Described is a specific embodiment of a method and device for determining the execution of handover or DSS offloading between frequencies (or frequency bands or cells corresponding thereto), based on at least one of an interval between initial transmissions (i.e., an initial transmission scheduling interval for a VoLTE service) of a quality of service class identifier-1 (QCI-1), the number of VoLTE terminals, the number of transmission time interval (TTI) bundling (TTI-B) or bundled TTI terminals, and uplink (UL) control channel element (CCE) fail rate.

The QCI-1 initial transmission scheduling (or allocation) interval may be also expressed in various similar methods, such as an initial transmission scheduling (or allocation) interval or an initial transmission packet interval for VoLTE terminals, and means an interval between scheduling for initial transmission for (enabled) VoLTE terminals (or QCI-1 terminals). More specifically, the interval may mean an interval between when providing buffer occupancy (BO) of QCI-1 and when allocating QCI-1. When the QCI-1 allocation is made, an interval (or its corresponding) value is initialized, and when BO remains even after allocation, the interval (or its corresponding) value may be increased again after initialization. When BO becomes 0 after allocation, the interval (or its corresponding) value may not be increased until BO is provided.

TTI-B is a technology typically used to improve the UL coverage of VoLTE terminals, and is a method of repeatedly four times providing and transmitting a transport block to which channel coding is applied. Each repetition block may also maximize a diversity effect by applying rate-matching with different redundancy version (RV) values. Also, codewords for the repetition blocks may be modulated and mapped to four consecutive UL sub-frames and be transmitted. Also, each of four TTI bundles may require single resource allocation and single HARQ acknowledgment (HARQ ACK) from a base station.

CCE may be used to transmit a PDCCH as a group of resources. Each CCE may consist of nine resource element groups (REGs), and may be grouped such as one CCE, two CCEs, four CCEs, or eight CCEs according to the size of a message to be transmitted. Here, REG is a unit of resource allocation and may be composed of four resource elements (REs), and RE may mean the smallest unit constituting a frame defined as one symbol and one subcarrier.

Prior to a description of a specific embodiment of the execution of inter-frequency or frequency-band handover or DSS offloading, a message between a medium access control (MAC) and a call processing block (call block) and a role thereof are explained for the understanding of meanings and roles of indicators necessary for an operation of a terminal or system. Here, the call processing block may mean an eNodeB call control block (ECCB) that manages terminal-unit parameters, or mean an eNodeB call management block (ECMB) that manages cell-unit parameters.

First, whether dynamic spectrum sharing (DSS) offloading is performed based on cell-unit indicators or parameters (e.g., OffloadingIndi0 or Ind_{OL0}), and whether to perform resource allocation (i.e., inter-frequency or frequency-band handover) for a new quality of service class identifier-1 (QCI-1) setup terminal in other bands (or cells) may be determined or indicated. At this time, a value of a corresponding indicator and whether to operate may be determined according to whether a specific condition defined in Embodiment 1 and Embodiment 2 to be described below is satisfied. (However, when a state corresponding to the indicator is not changed and a value thereof is not also changed, it may not be delivered to an upper layer, and in this case, the operation may be also performed according to a value of a previous indicator.)

The base station may determine and indicate whether or not to perform DSS offloading, based on a terminal-unit parameter (e.g., OffloadingIndi1 or Ind_{OL1}), and whether to perform resource allocation (i.e., inter-frequency or frequency-band handover) for a new TTI-B application (or entry) object UE in other bands (cells). At this time, a value of a corresponding indicator and whether to operate may be determined according to whether a specific condition defined in Embodiment 3 and Embodiment 4 to be described below is satisfied. For reference, the base station may check whether the specific condition is satisfied at a power headroom report (PHR) reception timing for each terminal, and transmit corresponding values when the condition is satisfied. Also, the base station may use a value such as 0/1 as an indicator indicating whether DSS offloading is possible, but may indicate all or at least one of a Call ID and a Cell Num (cell number) so as to specifically indicate which terminal in which cell to perform DSS offloading.

In general, when data traffic within a cell is increased, or when a total transmittable capacity is reduced due to a DSS operation, a probability of occurrence of service congestion between VoLTE terminals may increase. Also, since this phenomenon is likely to become more serious as the number of VoLTE terminals increases, when a probability of VoLTE service congestion between terminals within a cell increases, the base station may also perform resource allocation (i.e., inter-frequency or frequency-band handover) for a VoLTE terminal (or a new QCI-1 setup terminal) newly entering to control the number of VoLTE terminals or a quality of service, in other bands (or cells). In other words, the base station may appropriately predict a possibility of deterioration of the performance of VoLTE UEs in a DSS cell and perform handover or resource allocation to the newly entering VoLTE terminal in other bands or other cells, thereby controlling a quality of service of the new VoLTE terminal as well as the existing VoLTE terminals.

### Embodiment 1

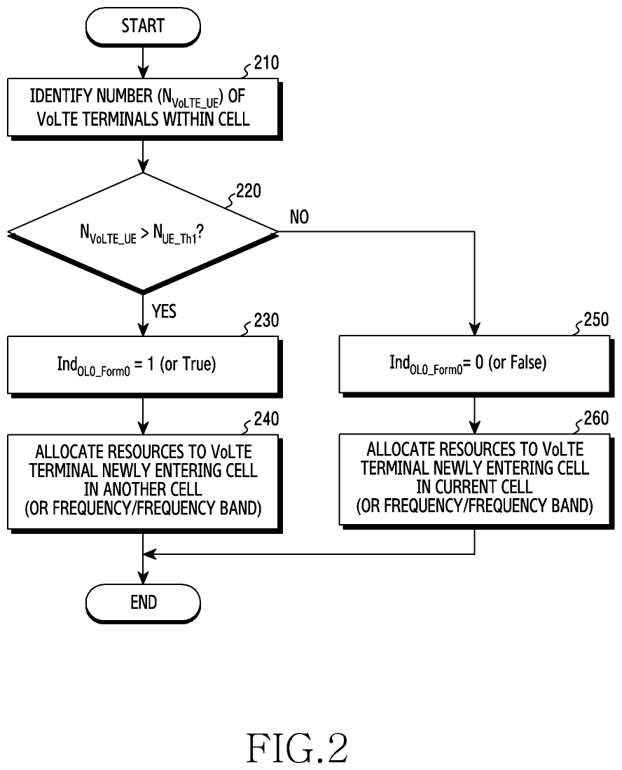

FIG. 2 illustrates a flowchart in which a base station controls a quality of service, based on the number of voice over long term evolution (VoLTE) terminals, according to an embodiment of the present disclosure. FIG. 2 describes a method in which the base station controls a quality of VoLTE service, based on the number of VoLTE terminals (or quality of service class identifier-1 (QCI-1) terminals) within a current cell.

Referring to FIG. 2, the base station may identify the number (N_{VoLTE_UE}) of VoLTE terminals within a cell (210). The base station may identify whether the identified number (N_{VoLTE_UE}) of VoLTE terminals exceeds (or is equal to or more than) a threshold or reference value (N_{UE_Th1}) of the N_{VoLTE_UE} predetermined in a system (or terminal/base station or some processors/modules) (220).

When the N_{VoLTE_UE} value exceeds (or is equal to or more than) the threshold (N_{UE_Th1}), the base station may determine that the number of terminals or the number of VoLTE terminals within a current cell exceeds a maximum value for maintaining a quality of service, and set an appropriate indicator value and deliver it to an upper layer (230), and allocate resources to a terminal newly entering the cell in another frequency band (or cell corresponding thereto) (240). For example, when the given condition is satisfied in step 220, the base station may set an indicator such as Ind_{OL0} or OffloadingIndi0 as a value corresponding to ‘True’ (e.g., 1) in a medium access control (MAC) and deliver it to an upper layer (e.g., ECCB) (230), and perform inter-frequency/frequency-band (or inter-cell) handover (or DSS offloading) as an ECCB operation (240).

When the given condition is not satisfied in step 220, the base station may determine that the quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB) (250), and prevent inter-frequency/frequency-band (or inter-cell) handover (or DSS offloading) from being performed. That is, the base station may perform resource allocation in the current cell (260). Or, when the given condition is not satisfied in step 220, the base station may also perform another operation in combination with another condition or determination result in step 250, although the base station determines that the quality of service may be maintained even if the number of VoLTE terminals within the current cell further increases.

For reference, when a state corresponding to the indicator is not changed and a value thereof is not also changed, the corresponding indicator may not be delivered to the upper layer.

Also, in this embodiment and all subsequent embodiments, the number (N_{VoLTE_UE}) of VoLTE terminals may be also defined as the number of VoLTE terminals within a current cell excluding a terminal attempting to newly enter the cell, and may be also defined as the number of terminals including the VoLTE terminal within the current cell and the terminal attempting to newly enter the cell, or a value corresponding thereto, according to the setting of a threshold. Also, the values corresponding to the True/False of the indicator may be reversed according to the definition of the indicator. Also, the current cell, the frequency or the frequency band may be referred to as a first cell, a first frequency or a first frequency band for convenience, and another cell, frequency or frequency band may be referred to as a second cell, a second frequency or a second frequency band for convenience.

### Embodiment 2

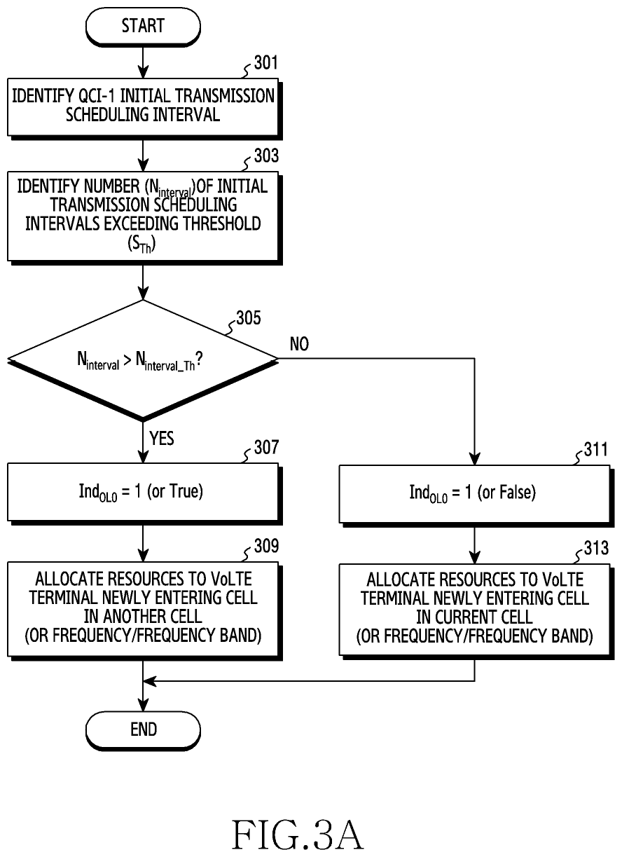

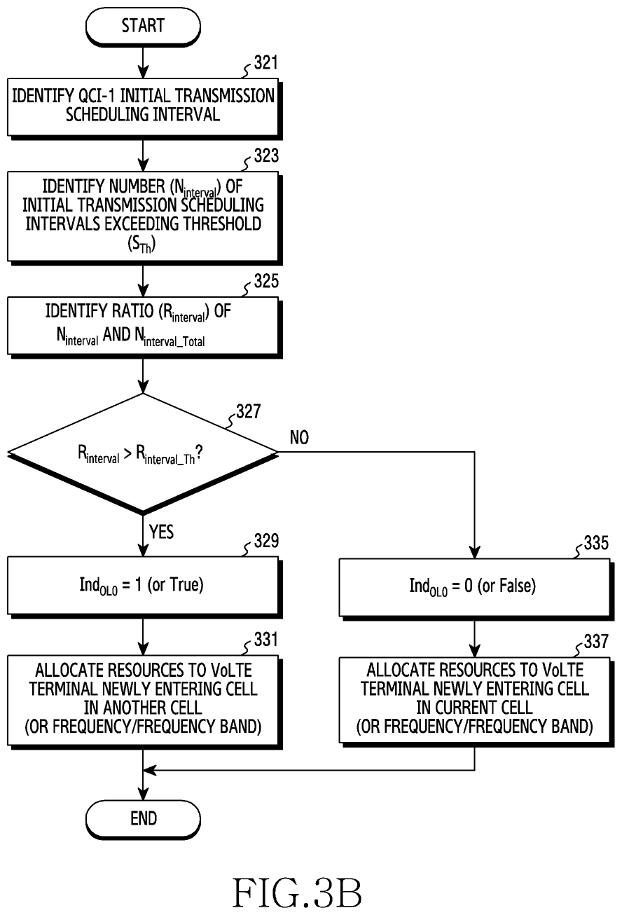

FIG. 3A illustrates a flowchart of controlling a quality of service, based on a quality of service class identifier-1 (QCI-1) initial transmission scheduling interval, according to an embodiment of the present disclosure. FIG. 3A describes a method for controlling the number of VoLTE terminals or the quality of service, based on the initial transmission allocation interval of the VoLTE terminal among parameters related to packet transmission of the voice over long term evolution (VoLTE) terminal (or QCI-1 terminal).

Referring to FIG. 3A, the base station may identify a QCI-1 initial transmission scheduling interval corresponding to a VoLTE terminal within a cell (301). When there are many enabled terminals within the current cell, there is a possibility of data transmission congestion due to insufficient transmission resources, so the QCI-1 initial transmission scheduling interval may increase, which may become more serious as the number of terminals or the number of VoLTE terminals increases. Therefore, S_{Th}, which is a specific threshold (or reference value), may be previously set for the QCI-1 initial transmission scheduling interval identified in step 301, and determine this situation. That is, as there are many cases in which the number of QCI-1 initial transmission scheduling intervals exceeds (or is equal to or more than) the threshold (Sn), the base station may approximately or indirectly determine whether the number of terminals or the number of VoLTE terminals within a current cell is (almost) saturated. For example, the base station may identify the number (Nᵢₙₜₑᵣᵥₐₗ) of cases where values of the QCI-1 initial transmission scheduling intervals identified in step 301 exceed (or are equal to or more than) the threshold Sn (303), and compare the Nᵢₙₜₑᵣᵥₐₗ with a N_{interval_Th} value which is a predetermined threshold (or reference value) (305). When the Nᵢₙₜₑᵣᵥₐₗ exceeds the N_{interval_Th}, the base station may determine that the number of terminals or the number of VoLTE terminals within the current cell has already exceeded a maximum value for maintaining a quality of service, and set an appropriate indicator value and deliver it to an upper layer (307), and perform an operation of allocating resources to a terminal newly entering the cell in another frequency band (or cell corresponding thereto) (309).

When the given condition is satisfied in step 305, the base station may set an indicator such as Ind_{OL0} or OffloadingIndi0 as a value corresponding to ‘True’ (e.g., 1) in a MAC, and deliver it to an upper layer (e.g., ECCB) and perform inter-frequency/frequency-band (or inter-cell) handover (or DSS offloading) as an ECCB operation.

When the given condition is not satisfied in step 305, the base station may determine that a quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB), and prevent the inter-frequency/frequency-band (or inter-cell) handover (or DSS offloading) from being performed. That is, the base station may perform resource allocation in the current cell. Or, when the given condition is not satisfied in step 305, the base station may also perform another operation in combination with another condition or determination result in step 311, although the base station determines that the quality of service may be maintained even if the number of VoLTE terminals within the current cell increases.

For reference, when a state corresponding to the indicator is not changed and a value thereof is not also changed, the indicator may not be delivered to the upper layer.

FIG. 3B is a flowchart in which a base station controls a quality of service, based on a QCI-1 initial transmission scheduling interval, according to an embodiment of the present disclosure. In FIG. 3B, a method in which the base station controls the number of VoLTE terminals or the quality of service, based on the QCI-1 initial transmission scheduling interval, is described.

Referring to FIG. 3B, the base station may identify QCI-1 initial transmission scheduling intervals corresponding to VoLTE terminals within a cell (321), and may identify the number (Nᵢₙₜₑᵣᵥₐₗ) of cases when values of the QCI-1 initial transmission scheduling intervals identified in step 321 exceed (or are equal to or more than) a threshold S_{T}h (323). In step 325, the base station may identify the ratio of the Nᵢₙₜₑᵣᵥₐₗ to the number (N_{interval_Total}) of QCI-1 initial transmissions of all terminals or a value (Rᵢₙₜₑᵣᵥₐₗ) corresponding to the ratio. In this case, the Rᵢₙₜₑᵣᵥₐₗ may be also defined as a ratio, such as Rᵢₙₜₑᵣᵥₐₗ=Nᵢₙₜₑᵣᵥₐₗ/N_{interval_Total}, or may be also defined by properly integerizing the ratio, such as Rᵢₙₜₑᵣᵥₐₗ=10^{a}*Nᵢₙₜₑᵣᵥₐₗ/N_{interval_Total}. For example, when a=4, it is defined as Rᵢₙₜₑᵣᵥₐₗ=10000*Nᵢₙₜₑᵣᵥₐₗ/N_{interval_Total}, which means a ratio of 1% when Rᵢₙₜₑᵣᵥₐₗ=100, a ratio of 0.1% when Rᵢₙₜₑᵣᵥₐₗ=10, and a ratio of 0.05% when Rᵢₙₜₑᵣᵥₐₗ=5. Also, in order to prevent unnecessary cases from being counted, the base station may also set a specific upper limit value (N_{interval_max}) for the number of the cases, such as (Nᵢₙₜₑᵣᵥₐₗ)*=min (Nᵢₙₜₑᵣᵥₐₗ, N_{interval_max}). The base station may compare the thus determined ratio or a value (Rᵢₙₜₑᵣᵥₐₗ) corresponding to the ratio with a R_{interval_Th} value which is a predetermined threshold (or reference value) (327). When the Rᵢₙₜₑᵣᵥₐₗ value exceeds the R_{interval_Th}, the base station may determine that the number of terminals or the number of VoLTE terminals within a current cell has already exceeded a maximum value for maintaining a quality of service, and set an appropriate indicator value and deliver it to an upper layer (329), and perform an operation of allocating resources to a terminal newly entering the cell in another frequency band (or cell corresponding thereto) (331).

When the given condition is satisfied in step 327, the base station may set an indicator such as Ind_{OL0} or OffloadingIndi0 as a value corresponding to ‘True’ (e.g., 1) in a MAC and deliver it to an upper layer (e.g., ECCB) (329), and perform inter-frequency/frequency-band (or inter-cell) handover (or DSS offloading) as an ECCB operation (331).

When the given condition is not satisfied in step 327, the base station may determine that a quality of service may be maintained even if the number of terminals or the number of VoLTE terminals within the current cell further increases, and set an indicator such as Ind_{OL0} or OffloadingIndi0 as a value corresponding to ‘False’ (e.g., 0) in the MAC, and deliver it to an upper layer (e.g., ECCB) (335), and prevent inter-frequency/frequency-band (or inter-cell) handover (or DSS offloading) from being performed. That is, the base station may perform resource allocation in the current cell (337). Or, when the given condition is not satisfied in step 327, the base station may also perform another operation in combination with another condition or determination result in step 335, although the base station determines that the quality of service may be maintained even if the number of VoLTE terminals within the current cell increases.

For reference, when a state corresponding to the indicator is not changed and a value thereof is not also changed, the indicator may not be delivered to the upper layer.

Also, the threshold S_{T}h may be set as a value within tens to hundreds of milli-seconds (ms) according to a system, or may use a fixed value according to the system or terminal/base station, or may be configurable with a variable value. Also, a duration (or period) of properly collecting (or observing) information on the QCI-1 initial transmission scheduling interval in order to determine the value of the Nᵢₙₜₑᵣᵥₐₗ or N_{interval_Total}, etc. may vary depending on a system and a system setting.

### Embodiment 3

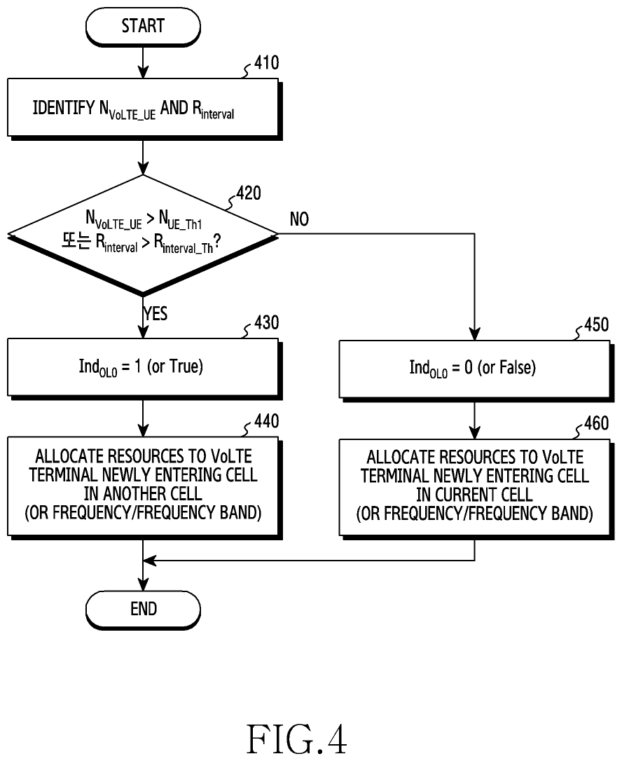

By appropriately combining the respective criteria applied in the Embodiment 1 and Embodiment 2, a new criterion for controlling the number of VoLTE terminals (i.e., the number of quality of service class identifier-1 (QCI-1) terminals) within a cell or a quality of service may be provided. As a specific embodiment, a method of combining two different criteria is shown in FIG. 4.

FIG. 4 is a flowchart in which a base station controls a quality of service, based on the number of VoLTE terminals and a QCI-1 initial transmission scheduling interval, according to an embodiment of the present disclosure.

Referring to FIG. 4, the base station may identify the number (N_{VoLTE_UE}) of VoLTE terminals within a cell and a ratio at which initial transmission scheduling intervals of the VoLTE terminals exceed a specific threshold or a value (Rᵢₙₜₑᵣᵥₐₗ) corresponding to the ratio (410). The base station may compare the N_{VoLTE_UE} and Rᵢₙₜₑᵣᵥₐₗ with thresholds or reference values (N_{UE_Th1} and R_{interval_Th}) predetermined in a system (or terminal/base station or some processors/modules), respectively, and identify whether the N_{VoLTE_UE} and Rᵢₙₜₑᵣᵥₐₗ exceed (or are equal to or more than) the thresholds or reference values (420).

When at least one of the given conditions is satisfied in step 420, the base station may determine that the number of terminals or the number of VoLTE terminals within a current cell has already exceeded a maximum value for maintaining a quality of service, and set an appropriate indicator value and deliver it to an upper layer (430), and allocate resources to a terminal newly entering the cell in another frequency band (or cell corresponding thereto) (440). For example, when the given condition is satisfied in step 420, the base station may set an indicator such as Ind_{OL0} or OffloadingIndi0 as a value corresponding to ‘True’ (e.g., 1) in the MAC and deliver it to the upper layer (e.g., ECCB) (430) and perform inter-frequency/frequency band (or inter-cell) handover (or DSS offloading) as an ECCB operation (440).

When all the given conditions are not satisfied in step 420, the base station may determine that a quality of service may be maintained even if the number of terminals or the number of VoLTE terminals within the current cell further increases, and set an indicator such as Ind_{OL0} or OffloadingIndi0 as a value corresponding to ‘False’ (e.g., 0) in a MAC and deliver it to an upper layer (e.g., ECCB) (450), and prevent inter-frequency/frequency-band (or inter-cell) handover (or DSS offloading) from being performed. That is, the base station may perform resource allocation in the current cell (460). Or, when all the given conditions are not satisfied in step 420, the base station may also perform another operation in combination with another condition or determination result in step 450, although the base station determines that the quality of service may be maintained even if the number of VoLTE terminals within the current cell further increases.

For reference, when a state corresponding to the indicator is not changed and a value thereof is not also changed, the indicator may not be delivered to the upper layer.

In the Embodiment 1 to Embodiment 3, an embodiment of performing inter-frequency/frequency-band (or inter-cell) handover according to whether specific conditions are satisfied is described. However, in general, a system may also determine whether to operate depending on a previous operation or a state of a previous indicator in regard to the operations of the Embodiment 1 to Embodiment 3. For example, since an indicator for determining whether to enable a DSS offloading operation exists (e.g., dss-offloading-enable), DSS offloading may or may not be performed based on a value of the corresponding indicator. As a specific example, when dss-offloading-enable=1 (or True), the DSS offloading operation is enabled and an operation for DSS offloading is performed as in the Embodiment 1 to Embodiment 3, and when dss-offloading-enable=0 (or False), the DSS offloading operation is disabled and the operation for DSS offloading may not be performed regardless of a situation within a cell. When the indicator is disabled, a value of an indicator or parameter (e.g., Ind_{OL0}, Ind_{OL1}, . . . or OffloadingIndi0, OffloadingIndi1, . . . ) related to DSS offloading is maintained as 0 (or False), and the DSS offloading operation may not be performed.

In addition, even if the indicator is in an enable state of the DSS offloading operation, whether or not to operate may be also determined differently depending on a value corresponding to the indicator (Ind_{OL0} or OffloadingIndi0) determining whether or not to perform actual DSS offloading in the Embodiment 1 to Embodiment 3. A specific embodiment of this is shown in Embodiment 4 below.

### Embodiment 4

First, for convenience of description, a scheme for determining DSS offloading, based on the number (N_{VoLTE_UE}) of VoLTE terminals within a cell and a ratio at which initial transmission scheduling intervals of VoLTE terminals exceed a specific threshold or a value (Rᵢₙₜₑᵣᵥₐₗ) corresponding to the ratio, is referred to as a first scheme (formula), and an intermediate indicator or parameter for determining a value of an indicator (Ind_{OL0} or OffloadingIndi0) indicating the execution of DSS offloading, based on the first scheme, is referred to as Ind_{OL0_Form0}. When there are a plurality of schemes of determining a DSS offloading operation in a system, there may be an indicator indicating to perform the DSS offloading operation, based on a specific scheme, in determining whether the DSS offloading operation is necessary. For example, when an indicator when indicating to determine whether the DSS offloading operation is necessary by applying the first scheme is formula0-enable, formula0-enable=1 (or True) may mean the enabling of a corresponding function, and formula0-enable=0 (or False) may mean disabling.

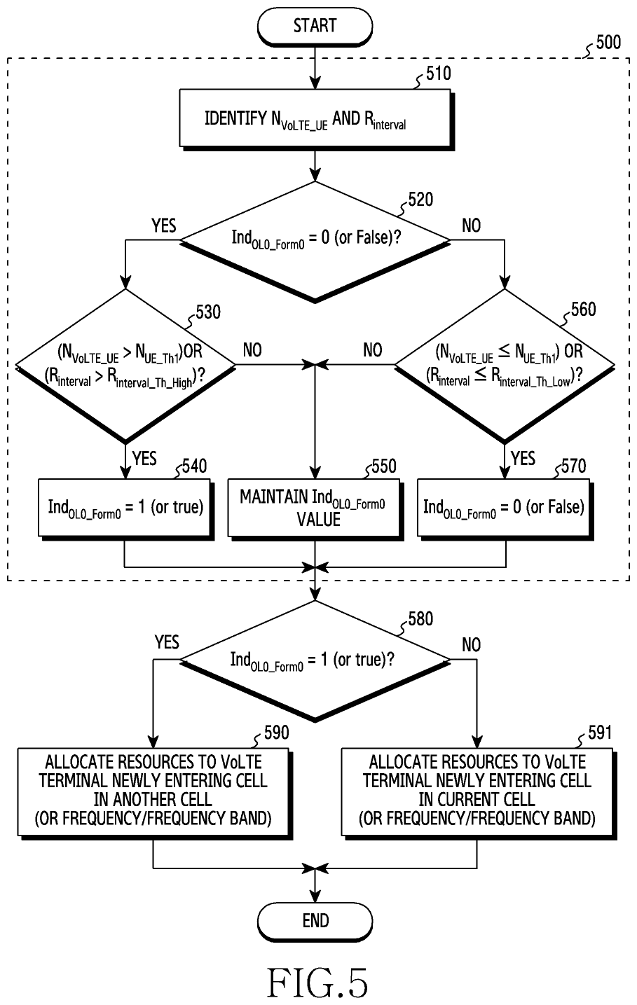

As a specific example, an embodiment of an operation of the base station when the indicator of the first scheme is enabled is shown in FIG. 5. (When the indicator is disabled such as formula0-enable=0 (or False), it means that Ind_{OL0} or OffloadingIndi0 or Ind_{OL0_Form0} values are maintained as 0 (or False), and whether the DSS offloading based on the first scheme is performed is not determined.)

FIG. 5 is a flowchart in which a base station controls a quality of service, based on the number of VoLTE terminals and a QCI-1 initial transmission scheduling interval, according to an embodiment of the present disclosure.

Referring to FIG. 5, the base station may identify the number (N_{VoLTE_UE}) of VoLTE terminals within a cell and a ratio at which initial transmission scheduling intervals of the VoLTE terminals exceed a specific threshold or a value (Rᵢₙₜₑᵣᵥₐₗ) corresponding to the ratio (510). Next, the base station may identify a value or state of a current indicator (520). (The order of operation of steps 510 and 520 may be changed.) For example, the base station may identify what value a parameter (Ind_{OL0_Form0}) has. When a DSS offloading operation is enabled and Ind_{OL0_Form0}=1, it may mean that DSS offloading is being performed when the VoLTE terminal enters a current cell, so the base station may determine whether to keep the DSS offloading operation, or to stop or release it. When Ind_{OL0_Form0}=0, there is a possibility in which the DSS offloading operation was performed under another condition, but at least according to a condition of the first scheme, DSS offloading does not have to be performed, so a process of determining whether DSS offloading based on the first scheme will not be kept being performed or whether the DSS offloading based on the first scheme will be performed may be required.

More specifically, when a value of the parameter (Ind_{OL0_Form0}) is 0 in step 520, the base station may expect that at least the DSS offloading operation based on the first scheme is not being performed. (There is a possibility that DSS offloading is performed under another condition.) Then, in next step 530, the base station may compare the N_{VoLTE_UE} and Rᵢₙₜₑᵣᵥₐₗ with thresholds or reference values (N_{UE_Th1} and R_{interval_Th_High}) predetermined in a system (or terminal/base station or some processors/modules) and identify whether the N_{VoLTE_UE} and Rᵢₙₜₑᵣᵥₐₗ exceed (or are equal to or more than) the thresholds or reference values.

When at least one of the given conditions is satisfied in step 530, the base station may determine that the number of terminals or the number of VoLTE terminals within a current cell has already exceeded a maximum value for maintaining a quality of service, and set an appropriate indicator or parameter value (e.g., Ind_{OL0_Form0}=1 or True) (540). In this case, since the value was initially changed from Ind_{OL0_Form0}=0 to Ind_{OL0_Form0}=1, the indicator or parameter value (Ind_{OL0_Form0}=1) may be also delivered to an upper layer. Also, the upper layer may control a DSS offloading operation to be performed. However, when all the conditions are not satisfied in step 530, Ind_{OL0_Form0}=0 may be maintained as it is (550). In this way, when the indicator or parameter value is not changed, the indicator or parameter value may not be delivered to the upper layer, or the DSS offloading operation may be controlled to maintain a stopped or released state.

When the value of the parameter (Ind_{OL0_Form0}) is 1 in step 520, the base station may expect that the DSS offloading operation is being performed based on at least the first scheme. Then, in next step 560, the base station may compare the N_{VoLTE_UE} and Rᵢₙₜₑᵣᵥₐₗ with the thresholds or reference values (N_{UE_Th1} and R_{interval_Th_Low}) predetermined in the system (or terminal/base station or some processors/modules), respectively, and identify whether the N_{VoLTE_UE} and Rᵢₙₜₑᵣᵥₐₗ are equal to or less than (or are less than) the thresholds or reference values. (Of course, similar to step 530, it may be implemented in a manner of comparing the N_{VoLTE_UE} and Rᵢₙₜₑᵣᵥₐₗ with the N_{UE_Th1} and R_{interval_Th_Low}, respectively, and determining whether at least one has a value exceeding or being equal to or more than.)

When all the given conditions are satisfied in step 560, the base station may determine that the number of terminals or the number of VoLTE terminals within the current cell has not reached a maximum value for maintaining a quality of service, and the base station may set an appropriate indicator or parameter value (e.g., Ind_{OL0_Form0}=0 or False) (570). In this case, since the value is changed from Ind_{OL0_Form0}=1 to Ind_{OL0_Form0}=0, the indicator or parameter value (Ind_{OL0_Form0}=0) may be delivered to the upper layer. Also, the upper layer may control to stop or release the execution of the DSS offloading operation. However, when at least one of the given conditions is not satisfied in step 560, Ind_{OL0_Form0}=1 may be maintained as it is (550). In this way, when the indicator or parameter value is not changed, the indicator or parameter value may not be also delivered to the upper layer, and the DSS offloading operation may be also kept being performed.

The thresholds (or reference values) set in steps 530 and 560 may be set as the same value, but may be set differently depending on whether DSS offloading is performed or not. For example, the threshold R_{interval_Th_High} for determining whether to perform DSS offloading when the DSS offloading is not being performed and the threshold R_{interval_Th_Low} for determining whether to stop or release the DSS offloading when the DSS offloading is being performed may be set as different values. As a specific example, since the DSS offloading operation is set to be performed even if at least one of the given conditions is satisfied in step 530, and the DSS offloading operation is set to be stopped or released when both the conditions are satisfied in step 560, the R_{interval_Th_High} may be set as a larger value than the R_{interval_Th_Low}, but is not necessarily limited in this way. (That is, the size may be reversed.) Also, in FIG. 5, the threshold (or reference value) N_{UE_Th1} set in steps 530 and 560 is set to be the same, but these values may be also set as different values such as N_{UE_Th1} and N_{UE_Th2}.

In addition, whether to perform the DSS offloading operation may be determined by further subdividing the conditions of steps 530 and 560. For example, the N_{VoLTE_UE} and Rᵢₙₜₑᵣᵥₐₗ may be independently compared with the predetermined thresholds or reference values (N_{UE_Th1} and R_{interval_Th_High}) in step 530, but a more detailed control is also possible by adding a condition as follows:

<<(N_{VoLTE_UE}>N_{UE_Th}) OR (Rᵢₙₜₑᵣᵥₐₗ>R_{interval_Th_High}) OR ((N_{VoLTE_UE}>N_{UE_Th2}) AND (Rᵢₙₜₑᵣᵥₐₗ>R_{interval_Th_High2}))>>.

(However, N_{UE_Th1}≥N_{UE_Th2}, R_{interval_Th_High}≥R_{interval_Th_High2})

In this way, whether to operate DSS offloading may be also determined by independently comparing each parameter, but whether to operate may be also determined by subdividing conditions according to a value range of each parameter.

When Ind_{OL0_Form0}=1 is finally determined by steps 540, 550, and 570, the base station may determine that the quality of service cannot be maintained when the number of VoLTE terminals within the current cell further increases, and set the indicator such as Ind_{OL0} or OffloadingIndi0 as the value corresponding to ‘True’ (e.g., 1) in the MAC and deliver it to the upper layer (e.g., ECCB) and perform the inter-frequency/frequency-band (or inter-cell) handover (or DSS offloading). That is, resource allocation may be performed in a cell different from the current cell (590).

When Ind_{OL0_Form0}=0 is finally determined, the base station may determine that the quality of service may be maintained even if the number of terminals or the number of VoLTE terminals within the current cell further increases, and set the indicator such as Ind_{OL0} or OffloadingIndi0 as the value corresponding to ‘False’ (e.g., 0) in the MAC and deliver it to the upper layer (e.g., ECCB) and prevent the inter-frequency/frequency-band (or inter-cell) handover (or DSS offloading) from being performed. That is, the base station may perform resource allocation in the current cell (591). Alternatively, the base station may also perform another operation in combination with another condition or determination result, although the base station determines by the value of Ind_{OL0_Form0}=0 that the quality of service may be maintained even if the number of VoLTE within the current cell further increases according to at least the first scheme.

For reference, when a state corresponding to the indicator or parameter is not changed from a previous state and a value thereof is also not changed, the indicator or parameter may not be also delivered to the upper layer.

The Embodiment 1 to Embodiment 4 have presented a method in which the base station determines whether to operate inter-cell or frequency/frequency-band handover (or DSS offloading) for a VoLTE UE, based on the number (N_{VoLTE_UE}) of VoLTE terminals within a cell and initial transmission scheduling intervals of the VoLTE terminals. Although there are various other methods as a method for controlling the number of VoLTE terminals within the cell or a quality of service as described above, the basic concept is to directly or indirectly determine whether or not the amount of resources to be allocated to the VoLTE terminals within the current cell is sufficient, thereby predicting a quality of service of a newly entering VoLTE terminal and, if necessary, performing an appropriate DSS offloading operation and maintaining the quality of service.

The following Embodiment 5 to Embodiment 7 show a method of determining whether DSS offloading is applied by indirectly predicting a quality of service of a VoLTE terminal according to the trend of the amount of resources allocated as described above.

### Embodiment 5

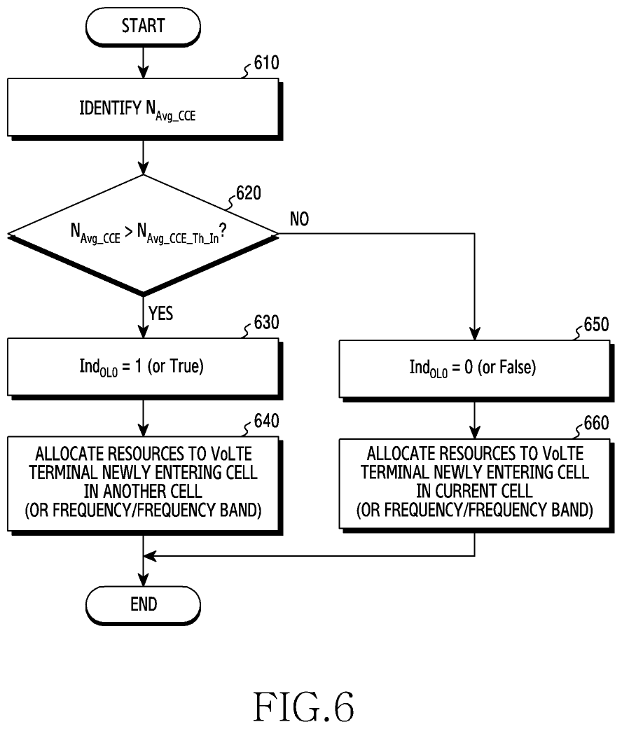

FIG. 6 is a flowchart in which a base station controls a quality of service, based on an average control channel element (CCE) size required for uplink and downlink, according to an embodiment of the present disclosure. In FIG. 6, a method of controlling a quality of voice over long term evolution (VoLTE) service, based on an amount of average allocated resources, is described.

Referring to FIG. 6, the base station may identify the number of average CCEs required for uplink (UL) and downlink (DL) or the number (N_{Avg_CCE}) corresponding thereto for all terminals within a cell (610). The base station may compare an average CCE size (N_{Avg_CCE}) required for UL and DL with a threshold or reference value (N_{Avg_CCE_Th_In}) of the N_{Avg_CCE} predetermined in a system (or terminal/base station or some processors/modules) and identify whether the average CCE size (N_{Avg_CCE}) exceeds the threshold or reference value (620).

When the N_{Avg_CCE} value exceeds (or is equal to or more than) the threshold, the base station may determine that the number of terminals or the number of VoLTE terminals within a current cell has already exceeded a maximum value for maintaining a quality of service, and set an appropriate indicator value and deliver it to an upper layer (630), and allocate resources to a newly entering terminal in another frequency band (or cell corresponding thereto) (640). For example, when the given condition is satisfied in step 620, the base station may set an indicator such as Ind_{OL0} or OffloadingIndi0 as a value corresponding to ‘True’ (e.g., 1) in a MAC and deliver it to the upper layer (e.g., ECCB) (630), and perform inter-frequency/frequency-band (or inter-cell) handover (or DSS offloading) as an ECCB operation (640).

When the given condition is not satisfied in step 620, the base station may determine that a quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB) (650) and prevent the inter-frequency/frequency-band (or inter-cell) handover (or DSS offloading) from being performed. That is, resource allocation may be performed in the current cell (660). Or, when the given condition is not satisfied in step 620, the base station may perform another operation in combination with another condition or determination result in step 650, although the base station determines that the quality of service may be maintained even if the number of VoLTE terminals within the current cell further increases.

For reference, when a state corresponding to the indicator is not changed and a value thereof is not also changed, the indicator may not be also delivered to the upper layer.

### Embodiment 6

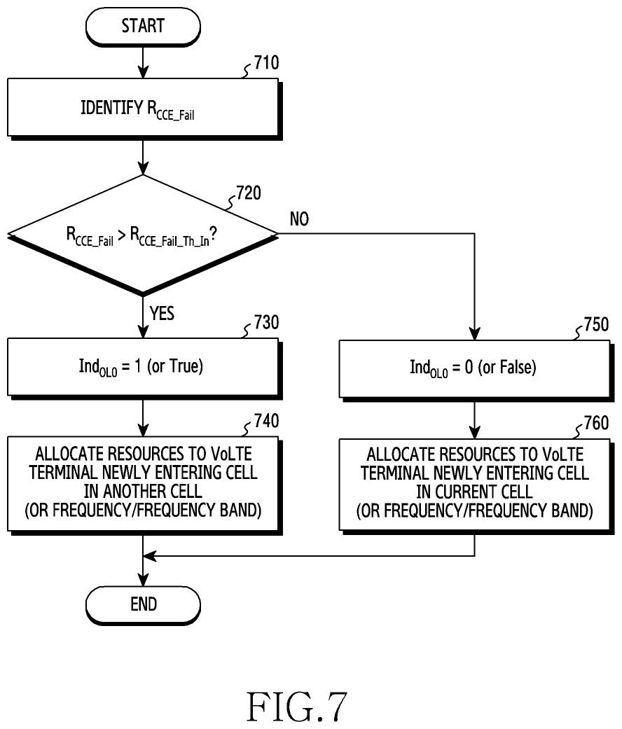

FIG. 7 is a flowchart in which a base station controls a quality of service, based on an uplink CCE fail rate, according to an embodiment of the present disclosure. In FIG. 7, as another method of controlling a quality of VoLTE service, a method of controlling the number of VoLTE terminals or a quality of service, based on a UL control channel element (UL CCE) fail rate or a value corresponding thereto, is described. (Hereinafter, it is referred to as a UL CCE fail rate for convenience)

Referring to FIG. 7, the base station may identify an uplink (UL) CCE fail rate (R_{CCE_Fail}) for terminals within a cell (710). When there are many enabled terminals within a current cell, the UL CCE fail rate may tend to increase relatively because there is a possibility of data transmission congestion due to insufficient transmission resources, which may become more serious as the number of terminals or the number of VoLTE terminals increases. Therefore, the base station may compare the UL CCE fail rate identified in step 710 with a R_{CCE_Fail_Th_In} value which is a specific threshold (or reference value), and when the R_{CCE_Fail} value is greater than the R_{CCE_Fail_Th_In}, the base station may determine that the number of terminals or the number of VoLTE terminals within the current cell has already exceeded a maximum value for maintaining a quality of service, and set an appropriate indicator value and deliver it to an upper layer (730), and allocate resources to a terminal newly entering the cell in another frequency band (or cell corresponding thereto) (740). For example, when the given condition is satisfied in step 720, the base station may set an indicator such as Ind_{OL0} or OffloadingIndi0 as a value corresponding to ‘True’ (e.g., 1) in a MAC and deliver it to the upper layer (e.g., ECCB) (730), and perform inter-frequency/frequency-band (or inter-cell) handover (or DSS offloading) as an ECCB operation (740).

When the given condition is not satisfied in step 720, the base station may determine that the quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB) (750) and prevent the inter-frequency/frequency-band (or inter-cell) handover (or DSS offloading) from being performed. That is, the base station may perform resource allocation in the current cell (760). Or, when the given condition is not satisfied in step 720, the base station may also perform another operation in combination with another condition or determination result in step 750, although the base station determines that the quality of service may be maintained even if the number of VoLTE terminals within the current cell further increases.

For reference, when a state corresponding to the indicator is not changed and a value thereof is not also changed, the indicator may not be delivered to the upper layer.

Also, a process of determining based on the UL CCE fail rate may be also performed by changing into a process of determining based on the number of UL CCE failures. For example, the number of failures may be defined as N_{CCE_Fail} instead of R_{CCE_Fail} and be determined by comparing with a threshold (or reference value) N_{CCE_Fail_Th_In} corresponding thereto. Of course, a duration (or period) of properly collecting (or observing) information on the number of UL CCE failures may vary depending on a system and a system setting.

### Embodiment 7

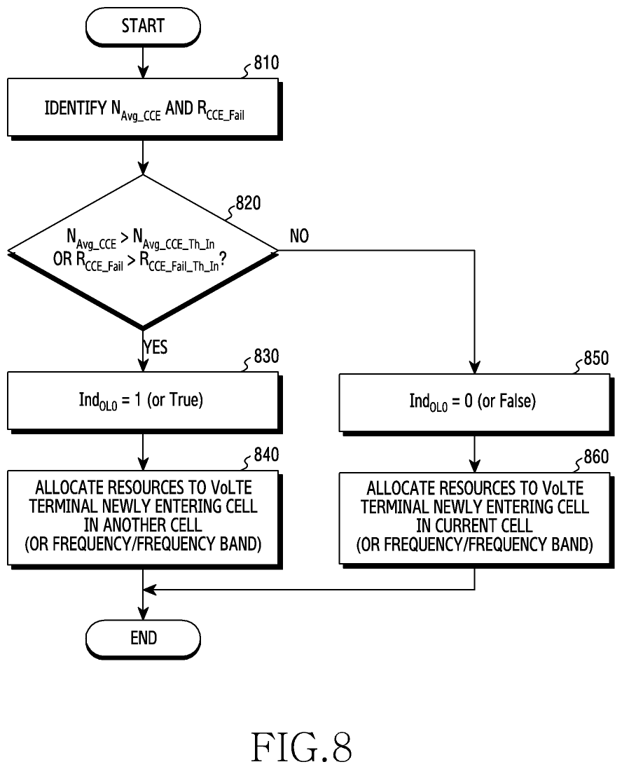

By appropriately combining the respective criteria applied in the Embodiment 5 and Embodiment 6, a new criterion for controlling the number of VoLTE terminals (i.e., the number of QCI-1 terminals) within a cell or a quality of service may be provided. As a specific embodiment, another method of combining two different criteria is shown in FIG. 8.

FIG. 8 is a flowchart in which a base station controls a quality of service, based on an average CCE required for uplink and downlink and an uplink CCE fail rate, according to an embodiment of the present disclosure.

Referring to FIG. 8, the base station may identify an average CCE size (N_{Avg_CCE}) required for uplink (UL) and downlink (DL) and a UL CCE fail rate (R_{CCE_Fail}) within a cell (810). Next, the base station may compare the N_{Avg_CCE} and R_{CCE_Fail} with thresholds or reference values (N_{Avg_CCE_Th_In} and R_{CCE_Fail_Th_In}) predetermined in a system (or terminal/base station or some processors/modules), respectively, and may identify whether the N_{Avg_CCE} and R_{CCE_Fail} exceed (or are equal to or more than) the thresholds or reference values (820).

When at least one of the given conditions is satisfied in step 820, the base station may determine that the number of terminals or the number of VoLTE terminals within a current cell has already exceeded a maximum value for maintaining a quality of service, and set an appropriate indicator value and deliver it to an upper layer (830), and allocate resources to a terminal newly entering the cell in another frequency band (or cell corresponding thereto) (840). For example, when the given condition is satisfied in step 820, the base station may set an indicator such as Ind_{OL0} or OffloadingIndi0 as a value corresponding to ‘True’ (e.g., 1) in a MAC and deliver it to the upper layer (e.g., ECCB) (830) and perform inter-frequency/frequency-band (or inter-cell) handover (or DSS offloading) as an ECCB operation (840).

When all the given conditions are not satisfied in step 820, the base station may determine that a quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB)(850) and prevent the inter-frequency/frequency-band (or inter-cell) handover (or DSS offloading) from being performed. That is, the base station may perform resource allocation in the current cell (860). Or, when all the given conditions are not satisfied in step 820, the base station may also perform another operation in combination with another condition or determination result in step 850, although the base station determines that the quality of service may be maintained even if the number of VoLTE terminals within the current cell further increases.

For reference, when a state corresponding to the indicator is not changed and a value thereof is not also changed, the indicator may not be delivered to the upper layer.

In the Embodiment 5 to Embodiment 7, an embodiment in which inter-frequency/frequency-band (or inter-cell) handover is performed according to whether specific conditions are satisfied is described. However, in general, a system may also determine whether to operate depending on a previous operation or a state of a previous indicator in regard to the operations of the Embodiment 5 to Embodiment 7. For example, since an indicator for determining whether to enable a DSS offloading operation exists (e.g., dss-offloading-enable), DSS offloading may or may not be performed based on a value of the corresponding indicator. In addition, even if the indicator is in an enable state of the DSS offloading operation, whether or not to operate may be determined differently, based on a value corresponding to the indicator (Ind_{OL0} or OffloadingIndi0) for determining whether or not to perform actual DSS offloading in the Embodiment 5 to Embodiment 7. A specific embodiment for this is shown in Embodiment 8 below.

### Embodiment 8

First, for convenience of description, a scheme in which DSS offloading is determined based on an average CCE size (N_{Avg_CCE}) required for uplink (UL) and downlink (DL) and a UL CCE fail rate (R_{CCE_Fail}) within a cell is referred to as a second scheme, and an intermediate indicator or parameter of determining a value of an indicator (Ind_{OL0} or OffloadingIndi0) indicating the execution of the DSS offloading, based on the second scheme, is referred to as Ind_{OL0_Form1}. When there are a plurality of schemes of determining a DSS offloading operation in a system, there may be an indicator indicating to perform the DSS offloading operation, based on a specific scheme, in determining whether the DSS offloading operation is necessary. For example, when an indicator when indicating to determine whether the DSS offloading operation is necessary by applying the second scheme is formula1-enable, formula1-enable=1 (or True) may mean the enabling of a corresponding function, and formula1-enable=0 (or False) may mean disabling.

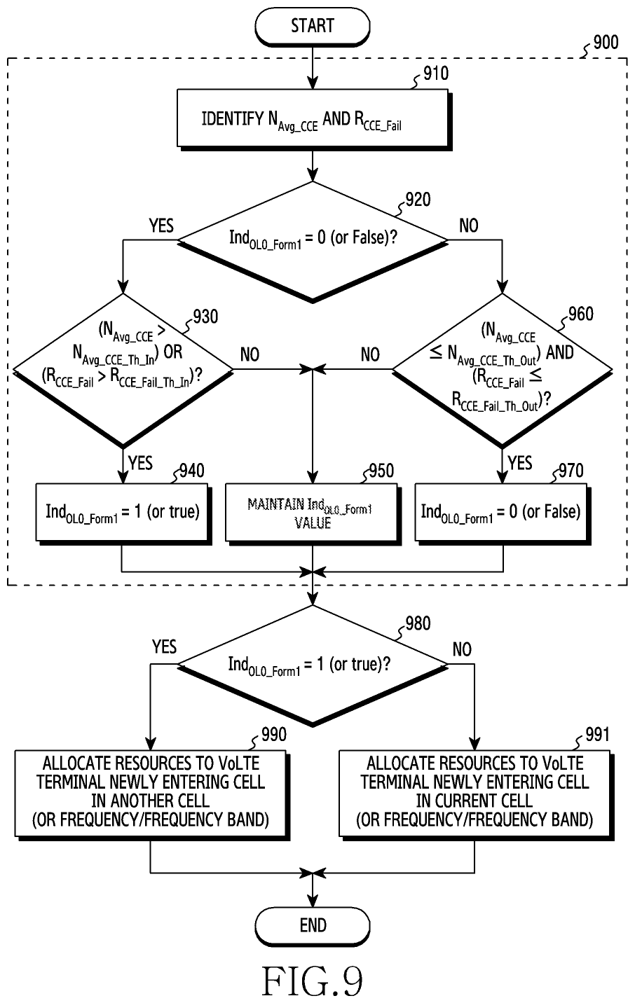

As a specific example, an embodiment of an operation when an indicator of the second scheme is enabled is illustrated in FIG. 9. (When the indicator is disabled such as formula1-enable=0 (or False), it means that Ind_{OL0} or OffloadingIndi0 or Ind_{OL0_Form1} values are maintained as 0 (or False), and whether DSS offloading is performed by the second scheme is not determined.)

FIG. 9 is a flowchart in which a base station controls a quality of service, based on an average CCE required for uplink and downlink and an uplink CCE fail rate, according to an embodiment of the present disclosure.

Referring to FIG. 9, the base station may identify an average CCE size (N_{Avg_CCE}) required for UL and DL and a UL CCE fail rate (R_{CCE_Fail}) (910). Then, the base station may identify a value or state of a current indicator (920). (The order of operation of steps 910 and 920 may be changed.) For example, the base station may identify what value a parameter (Ind_{OL0_Form1}) has. When a DSS offloading operation is enabled and Ind_{OL0_Form1}=1, it may mean that DSS offloading is being performed when a VoLTE terminal enters a current cell, so the base station may determine whether to keep the DSS offloading operation or to stop or release it. When Ind_{OL0_Form1}=0, there is a possibility that the DSS offloading operation was performed under another condition, but DSS offloading does not have to be performed at least according to a condition of the second scheme, so a process of determining whether not to keep performing DSS offloading based on the second scheme or to perform DSS offloading based on the second scheme may be required.

More specifically, when the value of the parameter (Ind_{OL0_Form1}) is 0 in step 920, it may be expected that the DSS offloading operation based on at least the second scheme is not being performed. (There is a possibility that DSS offloading is performed under another condition.) Then, in next step 930, the base station may compare the N_{Avg_CCE} and R_{CCE_Fail} with thresholds or reference values (N_{Avg_CCE_Th_In} and R_{CCE_Fail_Th_In}) predetermined in a system (or terminal/base station or some processors/modules), respectively, and identify whether the N_{Avg_CCE} and R_{CCE_Fail} exceed (or are equal to or more than) the thresholds or reference values.

When at least one or more of the given conditions are satisfied in step 930, the base station may determine that the number of terminals or the number of VoLTE terminals within a current cell has already exceeded a maximum value for maintaining a quality of service, and may set an appropriate indicator or parameter value (e.g., Ind_{OL0_Form1}=1 or True) (940). In this case, since the value is changed from Ind_{OL0_Form1}=0 to Ind_{OL0_Form1}=1, the indicator or parameter value (Ind_{OL0_Form1}=1) may be also delivered to an upper layer. Also, the upper layer may control a DSS offloading operation to be performed. However, when all the conditions are not satisfied in step 930, Ind_{OL0_Form1}=0 may be maintained as it is (950). In this way, when the indicator or parameter value is not changed, the indicator or parameter value may not be also delivered to the upper layer, and the DSS offloading operation may be also controlled to maintain a stopped or released state.

When the value of the parameter (Ind_{OL0_Form1}) is 1 in step 920, it may be expected that a DSS offloading operation based on at least the second scheme is being performed. Then, in next step 960, the base station may compare the N_{Avg_CCE} and R_{CCE_Fail} with thresholds or reference values (N_{Avg_CCE_Th_Out} and R_{CCE_Fail_Th_Out}) predetermined in a system (or terminal/base station or some processors/modules), respectively, and determine whether the N_{Avg_CCE} and R_{CCE_Fail} are equal to or less than (or are less than) the thresholds or reference values. (Of course, similar to step 930, it may be also implemented in a manner of comparing the N_{Avg_CCE} and R_{CCE_Fail} with the N_{Avg_CCE_Th_Out} and R_{CCE_Fail_Th_Out}, respectively, and determining whether at least one has a value exceeding or being equal to or more than.) When all the conditions are satisfied, the base station may determine that the number of terminals or the number of VoLTE terminals within a current cell has not reached a maximum value for maintaining a quality of service, and set an appropriate indicator or parameter value (e.g., Ind_{OL0_Form1}=0 or False) (970). In this case, since the value is first changed from Ind_{OL0_Form1}=1 to Ind_{OL0_Form1}=0, the indicator or parameter value (Ind_{OL0_Form1}=0) may be also delivered to the upper layer. Also, the upper layer may control to stop or release the execution of the DSS offloading operation. However, when at least one of the given conditions is not satisfied in step 960, Ind_{OL0_Form1}=1 may be maintained as it is (950). In this way, when the indicator or parameter value is not changed, the indicator or parameter value may not be also delivered to the upper layer, and the DSS offloading operation may also be kept being performed.

The threshold (or reference value) set in steps 930 and 960 may be set as the same value, but may be set differently depending on whether DSS offloading is performed or not. For example, the thresholds (N_{Avg_CCE_Th_In} and R_{CCE_Fail_Th_In}) for determining whether to perform DSS offloading when DSS offloading is not being performed and the thresholds (N_{Avg_CCE_Th_Out} and R_{CCE_Fail_Th_Out}) for determining whether to stop or release the execution of DSS offloading when DSS offloading is being performed may be set as different values. As a specific example, in step 930, the DSS offloading operation is set to be performed even if only one condition is satisfied, and in step 960, the DSS offloading operation is set to be stopped or released when both conditions are all satisfied, so the N_{Avg_CCE_Th_In} and R_{CCE_Fail_Th_In} may be set as larger values than the N_{Avg_CCE_Th_Out} and R_{CCE_Fail_Th_Out}, but are not necessarily limited in this way. (That is, the size may be reversed.)

In addition, whether to perform the DSS offloading operation may be also determined by further subdividing the conditions of steps 930 and 960. For example, in step 930, the N_{VoLTE_UE} and Rᵢₙₜₑᵣᵥₐₗ may be also independently compared with the predetermined thresholds or reference values (N_{UE_Th1} and R_{interval_Th_High}), respectively, but a more detailed control is also possible by adding a condition as follows:

<<(N_{Avg_CCE}>N_{Avg_CCE_Th_In}) OR (R_{CCE_Fail}>R_{CCE_Fail_Th_In}) OR ((N_{Avg_CCE}>N_{Avg_CCE_Th_In2}) AND (R_{CCE_Fail}>R_{CCE_Fail_Th_In2}))>>.

(However, N_{Avg_CCE_Th_In}≥N_{Avg_CCE_Th_In2}, R_{CCE_Fail_Th_In2}≥R_{CCE_Fail_Th_In2})

In this way, whether to operate DSS offloading may be also determined by independently comparing each parameter, but whether to operate may be also determined by subdividing conditions according to a value range of each parameter.

When Ind_{OL0_Form1}=1 is finally determined by steps 940, 950, and 970, the base station may determine that a quality of service cannot be maintained when the number of VoLTE terminals within a current cell further increases, and set an indicator such as Ind_{OL0} or OffloadingIndi0 as a value corresponding to ‘True’ (e.g., 1) in a MAC and deliver it to an upper layer (e.g., ECCB) and perform inter-frequency/frequency-band (or inter-cell) handover (or DSS offloading). That is, the base station may perform resource allocation in a cell different from the current cell (990). When Ind_{OL0_Form1}=0 is finally determined, the base station may determine that the quality of service may be maintained even if the number of terminals or the number of VoLTE terminals within the current cell further increases, and set the indicator such as Ind_{OL0} or OffloadingIndi0 as a value corresponding to ‘False’ (e.g., 0) in the MAC and deliver it to the upper layer (e.g., ECCB) and prevent the inter-frequency/frequency-band (or inter-cell) handover (or DSS offloading) from being performed. That is, the base station may perform resource allocation in the current cell (991). Of course, the base station may also perform another operation in combination with another condition or determination result, although the base station determines that the quality of service may be maintained even if the number of VoLTE terminals within the current cell further increases according to at least the second scheme by a value of Ind_{OL0_Form1}=0.

For reference, when a state corresponding to the indicator or parameter is not changed from a previous state and a value thereof is not also changed, the indicator or parameter may not be delivered to the upper layer.

The Embodiment 1 to Embodiment 8 have proposed a method for determining whether to perform inter-cell or frequency/frequency-band handover (or DSS offloading) for a VoLTE terminal, based on at least some values among the number (N_{VoLTE_UE}) of VoLTE terminals within a cell, initial transmission scheduling intervals of the VoLTE terminals, an average CCE size (N_{Avg_CCE}) required for UL and DL, or a UL CCE fail rate (R_{CCE_Fail}). In this way, as a method for controlling the number of VoLTE terminals within the cell or a quality of service, there may be various other methods, and a new method may be also applied through an appropriate combination of respective embodiments.

As a specific example, a method of appropriately combining the Embodiment 1 to Embodiment 8 is shown in Embodiment 9 below.

### Embodiment 9

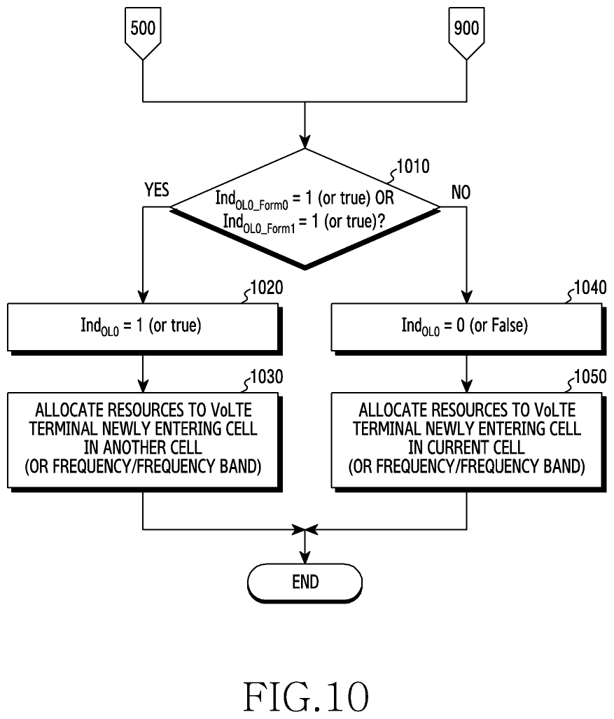

FIG. 10 illustrates a flowchart in which a base station controls a quality of service, based on at least one of the number of VoLTE terminals, a QCI-1 initial transmission scheduling interval, an average CCE required for uplink and downlink, or an uplink CCE fail rate, according to an embodiment of the present disclosure.

First, assume that step 500 in FIG. 5 of the Embodiment 4 and step 900 in FIG. 9 of the Embodiment 8 are performed identically. That is, a value of Ind_{OL0_Form0} is determined through step 500, and a value of Ind_{OL0_Form1} is determined through step 900. Based on the determined values, as in step 1010, the base station may determine an Ind_{OL0} value which is a final indicator or parameter, based on the Ind_{OL0_Form0} and Ind_{OL0_Form1} values, and perform an operation corresponding thereto. As a specific example, when even any one of the conditions Ind_{OL0_Form0}=1 (or True) or Ind_{OL0_Form1}=1 (or True) is satisfied in step 1010, the base station may set Ind_{OL0}=1 (or True) (1020) and deliver this value to an upper layer (e.g., ECCB), and perform inter-frequency/frequency-band (or inter-cell) handover (or DSS offloading) for a newly entering UE. That is, the base station may perform resource allocation in a cell different from the current cell (1030). When all the conditions Ind_{OL0_Form0}=1 (or True) or Ind_{OL0_Form1}=1 (or True) are not satisfied in step 1010, the base station may set Ind_{OL0}=0 (or False) (1040) and deliver this value to the upper layer (e.g., ECCB) and may prevent the inter-frequency/frequency-band (or inter-cell) handover (or DSS offloading) from being performed for a newly entering UE. That is, resource allocation may be performed in the current cell (1050).

For reference, when a state corresponding to the indicator or parameter (Ind_{OL0}) is not changed from a previous state and a value thereof is not also changed, the corresponding indicator or parameter may not be delivered to the upper layer, again. In this case, the existing value may be used as it is. Also, the using of operations 500 and 900 in FIG. 10 is changeable through appropriate modification and a combination of embodiments.

So far, the Embodiment 1 to Embodiment 9 have proposed a method of controlling the number of VoLTE terminals so as to maintain a quality of VoLTE service of a current cell, for a VoLTE terminal newly entering the current cell, that is, a method of performing inter-frequency (or inter-cell) handover or DSS offloading operation. However, this is only an example, and the methods of the Embodiment 1 to Embodiment 9 may be also applied even in other situations.

As a specific example, when service quality degradation is predicted for one of VoLTE terminals of a current cell due to a weak electric field or other reasons, a VoLTE service may be supported based on TTI-B. However, similar to when a new VoLTE terminal enters, when allocable resources are not sufficient within the current cell, a quality of VoLTE service or other data service may be deteriorated. Therefore, even when a VoLTE service is supported based on TTI-B, the same techniques as in the Embodiment 1 to Embodiment 9 may be also applied.

The Embodiment 1 to Embodiment 9 described so far have been basically described based on the number of VoLTE terminals or a control of a quality of VoLTE service, but are not limited thereto, and may be similarly applied to a UE for which various real-time data services (including VoIP services of other systems such as VoNR) are supported. Also, a more specific operation may be performed by appropriately combining the respective embodiments.

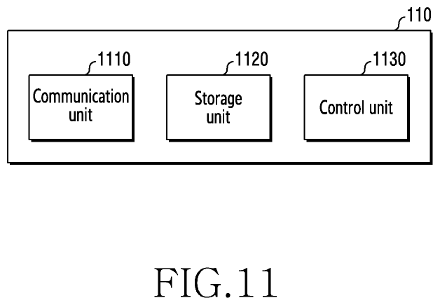

FIG. 11 illustrates a construction of a terminal according to various embodiments of the present disclosure. The construction illustrated in FIG. 11 may be understood as a construction of the terminal 110 of FIG. 1. Terms such as ‘ . . . unit’, ‘ . . . part’, etc. used below mean a unit that processes at least one function or operation, which may be implemented as hardware or software or a combination of hardware and software.

Referring to FIG. 11, the terminal 110 may include a communication unit 1110, a storage unit 1120, and a control unit 1130.

The communication unit 1110 may perform functions for transmitting and receiving signals through a wireless channel. For example, the communication unit 1110 may perform a conversion function between a baseband signal and a bit stream according to the physical layer standard of the system. For example, when transmitting data, the communication unit 1110 may provide complex symbols by encoding and modulating a transmission bit stream. Also, when receiving data, the communication unit 1110 may restore a baseband signal to a reception bit stream through demodulation and decoding. Also, the communication unit 1110 may up-convert a baseband signal into a radio frequency (RF) band signal and transmit the signal through an antenna, and down-convert an RF band signal received through the antenna into a baseband signal. To this end, the communication unit 1110 may include a transmit filter, a receive filter, an amplifier, a mixer, an oscillator, a digital-to-analog converter (DAC), an analog-to-digital converter (ADC), and the like.

Also, the communication unit 1110 may include a plurality of transmission/reception paths. Furthermore, the communication unit 1110 may include an antenna unit. The communication unit 1110 may include at least one antenna array composed of a plurality of antenna elements. In terms of hardware, the communication unit 1110 may include digital and analog circuits (e.g., a radio frequency integrated circuit (RFIC)). Here, the digital circuit and the analog circuit may be implemented in one package. Also, the communication unit 1110 may include a plurality of RF chains. The communication unit 1110 may perform beamforming. In order to give a directionality of the setting of the control unit 1130 to a signal to be transmitted and received, the communication unit 1110 may apply a beamforming weight to the signal.

Also, the communication unit 1110 may transmit and receive signals. To this end, the communication unit 1110 may include at least one transceiver. The communication unit 1110 may receive a downlink signal. The downlink signal may include a synchronization signal, a reference signal, a configuration message, control information, or downlink data, etc. Also, the communication unit 1110 may transmit an uplink signal. The uplink signal may include a random access related signal (e.g., random access preamble (RAP) and message 3 (Msg3)), a reference signal, a power headroom report (PHR), uplink data, etc.

Also, the communication unit 1110 may include different communication modules to process signals of different frequency bands. Furthermore, the communication unit 1110 may include a plurality of communication modules to support a plurality of different radio access technologies. For example, the different radio access technologies may include Bluetooth low energy (BLE), wireless fidelity (Wi-Fi), WiFi gigabyte (WiGig), cellular networks (e.g., long term evolution (LTE), new radio (NR)), etc. Also, the different frequency bands may include a super high frequency (SHF) (e.g., 2.5 GHz, 5 GHz) band and a millimeter wave (e.g., 38 GHz, 60 GHz, etc.) band. Also, the communication unit 1110 may use the same radio access technology on different frequency bands (e.g., unlicensed band for licensed assisted access (LAA), and citizens broadband radio service (CBRS) (e.g., 3.5 GHz)).

The communication unit 1110 may transmit and receive signals as described above. Accordingly, all or part of the communication unit 1110 may be referred to as a ‘transmitting unit’, a ‘receiving unit’, or a ‘transceiving unit’. Also, in the following description, transmission and reception performed through a wireless channel may be used as a meaning including the above-described processing by the communication unit 1110.

The storage unit 1120 may store data such as a basic program for operation of the terminal 110, an application program, setting information, etc. The storage unit 1120 may include a volatile memory, a non-volatile memory, or a combination of volatile and non-volatile memories. Also, the storage unit 1120 may present stored data according to a request of the control unit 1130.

The control unit 1130 may control overall operations of the terminal 110. For example, the control unit 1130 may transmit and receive signals through the communication unit 1110. Also, the control unit 1130 may write and read data in the storage unit 1120. And, the control unit 1130 may perform protocol stack functions required by communication standards. To this end, the control unit 1130 may include at least one processor. The control unit 1130 may include at least one processor or microprocessor, or may be a part of the processor. Also, a part of the communication unit 1110 and the control unit 1130 may be referred to as a communication processor (CP). The control unit 1130 may include various modules for performing communication. The control unit 1130 may control the terminal 110 to perform operations according to various embodiments described above.

The construction of the terminal 110 shown in FIG. 11 is only one example of the terminal, and examples of the terminal performing various embodiments are not limited from the construction shown in FIG. 11. That is, according to various embodiments, some constructions may be added, deleted, or changed.

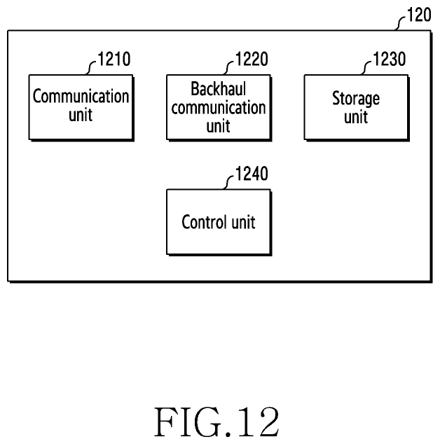

FIG. 12 illustrates a construction of a base station according to various embodiments of the present disclosure. The construction illustrated in FIG. 12 may be understood as a construction of the base station 120 of FIG. 1. Terms such as ‘ . . . unit’, ‘ . . . part’, etc. used below mean a unit that processes at least one function or operation, which may be implemented as hardware or software or a combination of hardware and software.

Referring to FIG. 12, the base station 120 may include a communication unit 1210, a backhaul communication unit 1220, a storage unit 1230, and a control unit 1240.

The communication unit 1210 may perform functions for transmitting and receiving signals through a wireless channel. For example, the communication unit 1210 may perform a conversion function between a baseband signal and a bit stream according to the physical layer standard of the system. For example, when transmitting data, the communication unit 1210 may provide complex symbols by encoding and modulating a transmission bit stream. Also, when receiving data, the communication unit 1210 may restore a baseband signal to a reception bit stream through demodulation and decoding. Also, the communication unit 1210 may up-convert a baseband signal into a radio frequency (RF) band signal and transmit the signal through an antenna, and down-convert an RF band signal received through the antenna into a baseband signal. To this end, the communication unit 1210 may include a transmit filter, a receive filter, an amplifier, a mixer, an oscillator, a digital-to-analog converter (DAC), an analog-to-digital converter (ADC), etc.

Also, the communication unit 1210 may include a plurality of transmission/reception paths. Furthermore, the communication unit 1210 may include at least one antenna array composed of a plurality of antenna elements. In terms of hardware, the communication unit 1210 may be composed of a digital unit and an analog unit, and the analog unit may be composed of a plurality of sub-units according to an operating power, an operating frequency, etc.

The communication unit 1210 may transmit and receive signals. To this end, the communication unit 1210 may include at least one transceiver. For example, the communication unit 1210 may transmit a synchronization signal, a reference signal, system information, a configuration message, control information, or data, etc. Also, the communication unit 1210 may perform beamforming.

The communication unit 1210 may transmit and receive signals as described above. Accordingly, all or part of the communication unit 1210 may be referred to as a ‘transmitter’, a ‘receiver’, or a ‘transceiver’. Also, in the following description, transmission and reception performed through a wireless channel may be used as a meaning including the above-described processing by the communication unit 1210.

The backhaul communication unit 1220 presents an interface for communicating with other nodes in a network. That is, the backhaul communication unit 1220 may convert a bit stream transmitted from the base station 120 to another node, for example, another access node, another base station, an upper node, a core network, etc., into a physical signal, and convert a physical signal received from another node into a bit stream.

The storage unit 1230 may store data such as a basic program for operation of the base station 120, an application program, setting information, etc. The storage unit 1230 may include a memory. The storage unit 1230 may include a volatile memory, a non-volatile memory, or a combination of volatile and non-volatile memories. Also, the storage unit 1230 may present stored data according to a request of the control unit 1240.

The control unit 1240 may control overall operations of the base station 120. For example, the control unit 1240 may transmit and receive signals through the communication unit 1210 or the backhaul communication unit 1220. Also, the control unit 1240 may write and read data in the storage unit 1230. And, the control unit 1240 may perform protocol stack functions required by communication standards. To this end, the control unit 1240 may include at least one processor. The control unit 1240 may control the base station 120 to perform the above-described operations of embodiments.

The construction of the base station 120 shown in FIG. 12 is only one example of the base station, and examples of the base station performing various embodiments are not limited from the construction shown in FIG. 12. That is, according to various embodiments, some constructions may be added, deleted, or changed.

A method performed by a base station in a wireless communication system of an embodiment described above may include steps of identifying initial transmission scheduling intervals of terminals within a first cell, and determining whether to allocate resources to a first terminal in a second cell, based on the initial transmission scheduling intervals.

An operating frequency band of the first cell may be different from an operating frequency band of the second cell.

The method may include the steps of identifying the number of specific intervals exceeding a first threshold among the initial transmission scheduling intervals, and performing the resource allocation to the first terminal in the second cell, when the number of specific intervals exceeds a second threshold.

The method may include the steps of identifying the number of specific intervals exceeding a first threshold among the initial transmission scheduling intervals, identifying the ratio of the number of initial transmission scheduling intervals to the number of specific intervals, and performing the resource allocation to the first terminal in the second cell, when the ratio exceeds a third threshold.

The method may include the steps of identifying the number of terminals within the first cell, and performing the resource allocation to the first terminal in the second cell, when the number of terminals within the first cell exceeds a fourth threshold.

The method may include the steps of identifying the number of terminals within the first cell, identifying the number of specific intervals exceeding a first threshold among the initial transmission scheduling intervals, identifying the ratio of the number of initial transmission scheduling intervals to the number of specific intervals, and performing the resource allocation to the first terminal in the second cell, when the number of terminals within the first cell exceeds a fourth threshold or the ratio exceeds a third threshold.

A base station in a wireless communication system of an embodiment as described above includes at least one transceiver and at least one processor operatively coupled with the at least one transceiver. The at least one processor may be configured to identify initial transmission scheduling intervals of terminals within a first cell, and determine whether or not to allocate resources to a first terminal in a second cell, based on the initial transmission scheduling intervals.

An operating frequency band of the first cell may be different from an operating frequency band of the second cell.

The at least one processor may be configured to identify the number of specific intervals exceeding a first threshold among the initial transmission scheduling intervals, and perform the resource allocation to the first terminal in the second cell when the number of specific intervals exceeds a second threshold.

The at least one processor may be configured to identify the number of specific intervals exceeding the first threshold among the initial transmission scheduling intervals, identify the ratio of the number of initial transmission scheduling intervals to the number of specific intervals, and perform the resource allocation to the first terminal in the second cell when the ratio exceeds a third threshold.

The at least one processor may be configured to identify the number of terminals within the first cell, and perform the resource allocation to the first terminal in the second cell when the number of terminals within the first cell exceeds a fourth threshold.

The at least one processor may be configured to identify the number of terminals within the first cell, identify the number of specific intervals exceeding the first threshold among the initial transmission scheduling intervals, and perform the resource allocation to the first terminal in the second cell when the number of terminals within the first cell exceeds the fourth threshold or the ratio exceeds the third threshold.

A method performed by a base station in a wireless communication system of an embodiment described above may include the steps of identifying the number of average control channel elements (CCEs) for terminals within a first cell, and determining whether to allocate resources to a first terminal in a second cell, based on the number of average CCEs.

An operating frequency band of the first cell may be different from an operating frequency band of the second cell.

The method may include the step of performing the resource allocation to the first terminal in the second cell, when the number of average CCEs exceeds a first threshold.

The method may include the steps of identifying an uplink CCE fail rate for the terminals within the first cell, and performing the resource allocation to the first terminal in the second cell, when the uplink CCE fail rate exceeds a second threshold.

The method may include the steps of identifying an uplink CCE fail rate for the terminals within the first cell, and performing the resource allocation to the first terminal in the second cell, when the number of average CCEs exceeds a first threshold or the uplink CCE fail rate exceeds a second threshold.

A base station in a wireless communication system of an embodiment as described above may include at least one transceiver and at least one processor operatively coupled with the at least one transceiver. The at least one processor may be configured to identify the number of average control channel elements (CCEs) for terminals within a first cell, and determine whether to allocate resources to a first terminal in a second cell, based on the number of average CCEs.

An operating frequency band of the first cell may be different from an operating frequency band of the second cell.

The at least one processor may be configured to perform the resource allocation to the first terminal in the second cell when the number of average CCEs exceeds a first threshold.

The at least one processor may be configured to identify an uplink CCE fail rate for the terminals within the first cell, and perform the resource allocation to the first terminal in the second cell when the uplink CCE fail rate exceeds a second threshold.

The at least one processor may be configured to identify the uplink CCE fail rate for the terminals within the first cell, and perform the resource allocation to the first terminal in the second cell when the number of average CCEs exceeds the first threshold or the uplink CCE fail rate exceeds the second threshold.

A method performed by a base station in a wireless communication system of an embodiment described above may include the steps of identifying the number of terminals within a first cell, and determining whether to allocate resources to a first terminal in a second cell, based on the number of terminals within the first cell.

The method may include the step of performing the resource allocation to the first terminal in the second cell, when the number of terminals within the first cell exceeds a threshold.

Methods of embodiments described in the claims or specification may be implemented in the form of hardware, software, or a combination of hardware and software.

When it is implemented by software, a computer readable storage medium storing one or more programs (software modules) may be presented. One or more programs stored in the computer-readable storage medium are configured for execution by one or more processors in an electronic device. The one or more programs include instructions that cause the electronic device to execute methods of embodiments described in the claims or specification.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or other optical storage devices, magnetic cassettes. Or, it may be stored in a memory composed of a combination of some or all of these. Also, each constructed memory may be included in multiple numbers.

Also, the program may be stored in an attachable storage device that may be accessed through a communication network such as the Internet, an intranet, a local area network (LAN), a wide area network (WAN), or a storage area network (SAN), or a communication network consisting of a combination thereof. Such a storage device may be connected to a device performing an embodiment through an external port. Also, a separate storage device on a communication network may be connected to a device performing an embodiment.

In the specific embodiments described above, components included in the disclosure are expressed in singular or plural number according to the specific embodiments presented. However, the expression of the singular or plural number is selected appropriately for the presented situation for convenience of description, and the present disclosure is not limited to singular or plural components, and even the component expressed in the plural number are composed of the singular number, or even the component expressed in the singular number may be composed of the plural number.

In the detailed description, specific embodiments have been described, but various modifications are possible without departing from the scope of the present disclosure. Therefore, the scope of the present disclosure should not be limited to and defined by the described embodiments and should be defined by the scope of the claims described below as well as equivalents to the scope of these claims.

1. A method performed by a base station in a wireless communication system, the method comprising:
identifying initial transmission scheduling intervals of terminals within a first cell; and
determining whether to allocate resources to a first terminal in a second cell, based on the initial transmission scheduling intervals.

2. The method of claim 1, wherein an operating frequency band of the first cell is different from an operating frequency band of the second cell.

3. The method of claim 1, the method further comprising:
identifying a number of specific intervals exceeding a first threshold among the initial transmission scheduling intervals; and
performing resource allocation to the first terminal in the second cell, when the number of the specific intervals exceeds a second threshold.

4. The method of claim 1, the method further comprising:
identifying a number of specific intervals exceeding a first threshold among the initial transmission scheduling intervals;
identifying a ratio of a number of the initial transmission scheduling intervals to the number of the specific intervals; and
performing resource allocation to the first terminal in the second cell, when the ratio exceeds a third threshold.

5. The method of claim 1, comprising the steps of:
identifying a number of the terminals within the first cell; and
performing resource allocation to the first terminal in the second cell, when the number of the terminals within the first cell exceeds a fourth threshold.

6. The method of claim 1, the method further comprising:
identifying a number of the terminals within the first cell;
identifying a number of specific intervals exceeding a first threshold among the initial transmission scheduling intervals;
identifying ratio of number of the initial transmission scheduling intervals to the number of the specific intervals; and
performing resource allocation to the first terminal in the second cell, when number of the terminals within the first cell exceeds a fourth threshold or the ratio exceeds a third threshold.

7. A method performed by a base station in a wireless communication system, the method comprising:
identifying a number of average control channel elements (CCEs) for terminals within a first cell; and
determining whether to allocate resources to a first terminal in a second cell, based on the number of average CCEs.

8. The method of claim 7, wherein an operating frequency band of the first cell is different from an operating frequency band of the second cell.

9. The method of claim 7, the method further comprising performing resource allocation to the first terminal in the second cell, when the number of average CCEs exceeds a first threshold.

10. The method of claim 7, the method further comprising:
identifying an uplink CCE fail rate for the terminals within the first cell; and
performing resource allocation to the first terminal in the second cell, when the uplink CCE fail rate exceeds a second threshold.

11. The method of claim 7, the method further comprising:
identifying an uplink CCE fail rate for the terminals within the first cell; and
performing resource allocation to the first terminal in the second cell, when the number of average CCEs exceeds a first threshold or the uplink CCE fail rate exceeds a second threshold.

12. A method performed by a base station in a wireless communication system, the method comprising:
identifying a number of terminals within a first cell; and
determining whether to allocate resources to a first terminal in a second cell, based on the number of the terminals within the first cell.

13. The method of claim 12, the method further comprising performing resource allocation to the first terminal in the second cell, when the number of the terminals within the first cell exceeds a threshold.

14. The method of claim 1,
wherein each of the terminals within the first cell and the first terminal in the second cell is a voice over long term evolution (VoLTE) terminal; and
wherein each of the initial transmission scheduling intervals is a quality of service class identifier-1 (QCI-1) initial transmission scheduling interval.

15. A method performed by a base station in a wireless communication system, the method comprising:
identifying initial transmission scheduling intervals of terminals within a first cell;
identifying a number of average control channel elements (CCEs) for terminals within the first cell; and
determining whether to allocate resources to a first terminal in a second cell, based on the initial transmission scheduling intervals or the number of average CCEs.

16. The method of claim 15, wherein an operating frequency band of the first cell is different from an operating frequency band of the second cell.

17. The method of claim 1, the method further comprising:
identifying a number of specific intervals exceeding a first threshold among the initial transmission scheduling intervals; and
performing resource allocation to the first terminal in the second cell, when the number of the specific intervals exceeds a second threshold or when the number of average CCEs exceeds a fifth threshold.

18. The method of claim 15, the method further comprising:
identifying a number of specific intervals exceeding a first threshold among the initial transmission scheduling intervals;
identifying a ratio of a number of the initial transmission scheduling intervals to the number of the specific intervals;
identifying an uplink CCE fail rate for the terminals within the first cell; and
performing resource allocation to the first terminal in the second cell, when the uplink CCE fail rate exceeds a second threshold or when the ratio exceeds a sixth threshold.

19. The method of claim 15, the method further comprising:
identifying number of the terminals within the first cell;
identifying a number of specific intervals exceeding a first threshold among the initial transmission scheduling intervals;
identifying ratio of number of the initial transmission scheduling intervals to the number of the specific intervals;
identifying an uplink CCE fail rate for the terminals within the first cell; and
performing resource allocation to the first terminal in the second cell, when the number of average CCEs exceeds a first threshold or the uplink CCE fail rate exceeds a second threshold
performing resource allocation to the first terminal in the second cell, when number of the terminals within the first cell exceeds a fourth threshold, when the ratio exceeds a third threshold, when the number of average CCEs exceeds a fifth threshold, or when the uplink CCE fail rate exceeds a sixth threshold.

20. The method of claim 15,
wherein each of the terminals within the first cell and the first terminal in the second cell is a voice over long term evolution (VoLTE) terminal; and
wherein each of the initial transmission scheduling intervals is a quality of service class identifier-1 (QCI-1) initial transmission scheduling interval.
